(19) United States
(12) Patent Application Publication
(10) Pub. No.: US 2004/0222583 A1
(43) Pub. Date: Nov. 11, 2004

(54) Method of, and apparatus for, processing sheets further to produce multi-leaf printed products

(75) Inventors: Georg Dannemann, Backnang (DE); Klaus Stocklossa, Marbach (DE); Eberhard Krieger, Weinstadt-Struempfelbach (DE)

Correspondence Address: ROTHWELL, FIGG, ERNST & MANBECK, P.C., 1425 K STREET, N.W., SUITE 800, WASHINGTON, DC, 20005, US

(73) Assignee: Maschinenbau Oppenweiler Binder GmbH & Co. KG, Oppenweiler (DE)

(21) Appl. No.: 10/832,402

(22) Filed: Apr. 27, 2004

(30) Foreign Application Priority Data
Sep. 23, 2003 (DE) 103 44 028.3
May 8, 2003 (DE) 03 010 429.3

(51) Int. Cl. B41L 43/00

(52) U.S. Cl. 270/32

(57) ABSTRACT

In the case of the method of, and the apparatus for, processing sheets further to produce multi-leaf printed products, a plurality of sheets (20) are folded around a folding line (30) and are then collated one above the other such that the folding line (30) is located at the top and the folded sheets (20) open in the downward direction. An adhesive (34) is applied to the sheets (20), in the region of the folding line (30), prior to collation.

### FIELD OF THE INVENTION

The invention relates to a method of, and to an apparatus for, processing sheets further to produce multi-leaf printed products.

### DESCRIPTION OF THE BACKGROUND ART

DE 102 20 550 A1 discloses an apparatus of the generic type which is intended for processing sheets further to produce multi-leaf printed products and has a buckle folder by means of which a sheet is folded transversely to the sheet-running direction. The buckle folder is followed by a knife folder, by means of which the sheet coming from the buckle folder is folded in the sheet-running direction by a folding knife introducing the sheet between two folding rollers which can be rotated in opposite directions. Arranged beneath the folding rollers is a feeder drum, which receives the folded sheet by means of a gripper. A sheet opener formed from two transporting rollers which can be rotated in opposite directions is arranged beneath the feeder drum. Located beneath the sheet opener is a transporting rail, on which the open sheets are set down one above the other. The sheets which are folded by the knife folder pass through the knife folder such that the folding edge is located at the bottom and the sheet opens in the upward direction. The feeder drum turns the sheet round such that the folding edge is located at the top and the sheet opens in the downward direction, in order that it can be set down on the transporting rail. Once the sheets which are necessary for a printed product have been positioned one above the other on the transporting rail, the sheets which are positioned one above the other are fed, by way of the transporting rail, to a binding device.

The arrangement of the feeder drum for reversing the sheets involves very high outlay in design terms. Furthermore, an additional operating step is necessary in order for the sheet which passes out of the knife folder to be set down on the transporting rail. More time is lost in that the sheets, in the first instance, have to be collated on the transporting rail before being fed together to the binding device.

### SUMMARY OF THE INVENTION

The object of the invention is, using means of straight-forward design, to provide a method and an apparatus which are intended for processing sheets further to produce multi-leaf printed products and make it possible, with relatively low design outlay, to achieve a high production capacity.

This object is achieved according to the invention by a method of processing sheets further to produce multi-leaf printed products, wherein a plurality of sheets are folded around a folding line and are then collated one above each other such that said folding line is located at the top and said folded sheets open downwardly, wherein an adhesive is applied to said sheets, in a region of said folding line, prior to collation.

An apparatus for carrying out the method of the present invention comprises a collating device in which said folded sheets are collated one above each other such that said folding line is located at the top and said folded sheets open in the downward direction, which comprises an adhesive-applying device which applies an adhesive to said sheets, in the region of said folding line, prior to collation.

Since the adhesive is applied to the sheets, in the region of the folding line, prior to collation, the sheets are already connected to one another when collated. A further step for connecting the individual sheets is not absolutely necessary.

The adhesive can optionally be applied to the upper side of the sheets or to the underside of the sheets.

### BRIEF DESCRIPTION OF THE DRAWINGS

Exemplary embodiments of the invention are explained in more detail hereinbelow with reference to drawings, in which:

FIG. 1 shows a first embodiment of an apparatus for processing sheets further to produce a printed product; and

FIG. 2 shows a second embodiment of an apparatus for processing sheets further to produce a printed product.

### DETAILED DESCRIPTION OF THE INVENTION

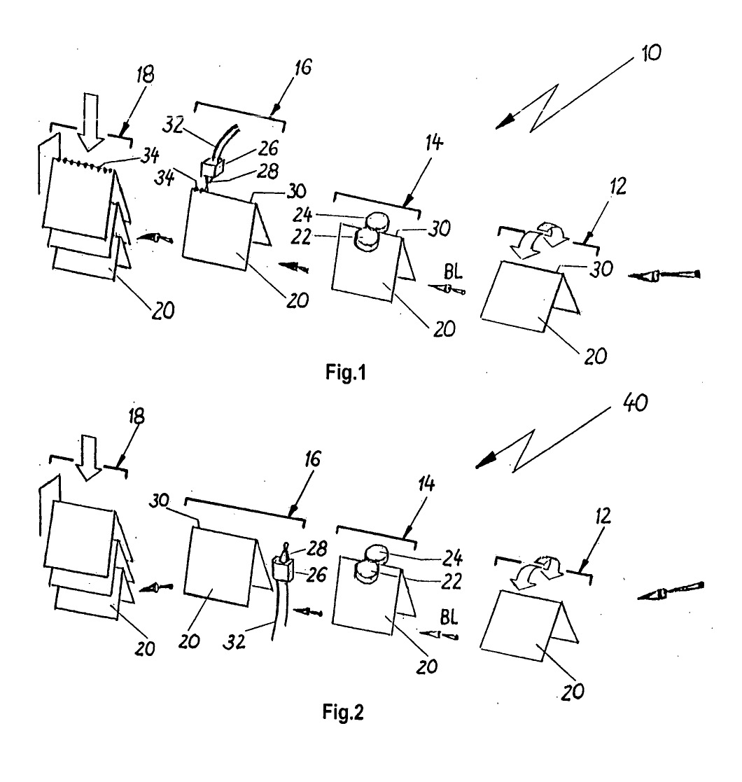

The apparatus 10, shown in FIG. 1, for processing a sheet further to produce a printed product has, one after the other in the sheet-running direction BL, a folding device 12, a pressing-roller device 14, an adhesive-applying device 16 and a collating device 18. The folding device 12 is formed by a former folder, by means of which a sheet 20 coming from a sheet feeder (not shown) is folded along its center line extending in the sheet-running direction BL such that the folding line 30 is located at the top and the sheet 20 opens in the downward direction. The sheet 20 is then fed to the pressing-roller device 14, which comprises two pressing rollers 22, 24 which press the sheet 20 in the region of the folding line 30 in order to give a defined folding line 30.

The adhesive-applying device 16 has an adhesive-bonding head 26 with an adhesive-bonding nozzle 28 provided on its end side. The adhesive-bonding head 26 is connected to a reservoir of adhesive via a line 32. The adhesive-bonding nozzle 28 is arranged directly above the folding line 30 when the sheet 20 is fed to the adhesive-applying device 16. Controlled by a control device (not shown), the adhesive-applying device 16 applies spots 34 of adhesive to the folding line 30 from above at a predetermined spacing and in a predetermined quantity. The sheets 20 are then collated one above the other, and connected to one another by the adhesive 34, in the collating device 18.

The apparatus 40, which is shown in FIG. 2, differs from the apparatus which is shown in FIG. 1 in that the adhesive-bonding head with the adhesive-bonding nozzle 28 is arranged beneath the sheet 20. In the case of this apparatus 40, the adhesive is applied to the folding line 30 from beneath.

What is claimed:

1. A method of processing sheets further to produce multi-leaf printed products, wherein a plurality of sheets are folded around a folding line and are then collated one above each other such that said folding line is located at the top and said folded sheets open downwardly, wherein an adhesive is applied to said sheets, in a region of said folding line, prior to collation.

2. The method as claimed in claim 1, wherein said adhesive is applied to an upper side of said sheets.

3. The method as claimed in claim 1, wherein said adhesive is applied to an underside of said sheets.

4. An apparatus for processing sheets further to produce multi-leaf printed products, having a folder for folding sheets around a folding line, and comprising a collating device in which said folded sheets are collated one above each other such that said folding line is located at the top and said folded sheets open in the downward direction, which comprises an adhesive-applying device which applies an adhesive to said sheets, in the region of said folding line, prior to collation.

5. The apparatus as claimed in claim 4, wherein said adhesive-applying device is designed and arranged such that said adhesive is applied to an upper side of said sheets.

6. The apparatus as claimed in claim 4, wherein said adhesive-applying device is designed and arranged such that said adhesive is applied to an underside of said sheets.
